(19) United States
(12) Patent Application Publication
(10) Pub. No.: US 2008/0119380 A1
(43) Pub. Date: May 22, 2008

(54) Cleansing Agent

(76) Inventors: Kyoko Okada, Wakayama (JP); Motomitsu Hasumi, Wakayama (JP)

Correspondence Address: BIRCH STEWART KOLASCH & BIRCH, PO BOX 747, FALLS CHURCH, VA, 22040-0747, US

(21) Appl. No.: 11/791,665

(22) PCT Filed: Oct. 24, 2005
(86) PCT No.: PCT/JP05/19500

§ 371 Date: May 25, 2007

(30) Foreign Application Priority Data
Dec. 9, 2004 (JP) 2004-357238

(51) Int. Cl. C11D 3/37

(52) U.S. Cl. 510/361

(57) ABSTRACT

A detergent containing a water-soluble pectin as a cleaning ingredient, a liquid detergent for fabric containing a water-soluble pectin, and a method for washing a fabric product, including the steps of applying the liquid detergent for fabric to the fabric product, and then carrying out wet cleaning. Even in a case where a washing machine is used, solid stains can be remarkably washed away from clothes.

### TECHNICAL FIELD

The present invention relates to a detergent, and more specifically to a liquid detergent for fabric, as well as a method for washing a fabric product using the detergent.

### BACKGROUND ART

Conventionally, it has been known that, among stains adhered to clothes, it is very difficult to remove dust stains such as dirt or soot because particles, which are a main component of stains, are stuck between fibers of the clothes.

Accordingly, detergents having improved detergency against these particle stains have conventionally been developed (see, for example, Patent Publications 1 to 2).

However, especially in a case where a washing machine is used, these particle stains are likely to remain because the mechanical force (stream of water) is less likely to be applied between the fibers where the particles are stuck. Furthermore, in recent years, there has been a trend to lower the mechanical force of the washing machine in response to the consumers' needs for careful washing of clothes, so that the level of cleaning against particle stains on clothes is increasingly lowered.
Patent Publication 1: JP2001-187900 A
Patent Publication 2: JP2001-49298 A
Patent Publication 3: JP2001-49299 A

### DISCLOSURE OF THE INVENTION

### Problems to be Solved by the Invention

Accordingly, as a result of intensive studies in order to obtain a detergent having a high cleaning performance on solid stains even with low mechanical forces of recent washing machines, the present inventors have found for the first time that a water-soluble pectin, which has not conventionally been recognized as a cleaning agent, surprisingly has a high cleaning performance, and the present invention has been perfected thereby.

Specifically, an object of the present invention is to provide a detergent capable of remarkably washing away solid stains from clothes even when a washing machine is used; a liquid detergent for fabric containing the cleaning agent; and a method for preparing the liquid detergent for fabric.

Incidentally, pectin, which is a water-soluble polymer substance occurring mostly in plants, is used as a gelatinizing agent, a thickening agent, or the like. However, it has not been known that pectin has a high cleaning performance on solid stains.

### Means to Solve the Problems

Specifically, the gist of the present invention relates to:
[1] a detergent containing a water-soluble pectin as a cleaning ingredient;
[2] a liquid detergent for fabric, containing a water-soluble pectin; and
[3] a method for washing a fabric product, including the steps of applying the liquid detergent for fabric described in the above [2] to the fabric product, and then carrying out wet cleaning.

### Effects of the Invention

By using the detergent of the present invention, there is exhibited an effect that solid stains on clothes can be remarkably washed away even when a washing machine is used.

### BEST MODE FOR CARRYING OUT THE INVENTION

As described above, the detergent of the present invention contains a water-soluble pectin as a cleaning ingredient. In the present invention, since the water-soluble pectin is used as a cleaning ingredient, there is exhibited an excellent effect that various stains adhered to fabrics, especially solid particle stains such as dirt or dust, can be remarkably washed away.

Especially the detergent of the present invention has an excellent cleaning performance on solid stains even when a washing machine having a low mechanical force is used.

Here, in the present invention, although the mechanism in that a water-soluble pectin washes away solid stains is not elucidated enough, it may be presumably as follows:

Specifically, since the detergency against solid stains is dependent upon the mechanical force, solid stains on the inside of a cloth to which the mechanical force is less likely to be applied during washing are likely to remain. When the detergent of the present invention is applied to stains, the cleaning ingredient pectin is permeated into the inside of the cloth to exhibit interaction with the stains, and thereafter the stains are washed away together with the pectin when wet cleaning is carried out.

According to this mechanism, it is believed that the water-soluble pectin exhibits an excellent cleaning performance.

The water-soluble pectin used in the present invention includes pectinic acid and pectic acid.

The water-soluble pectin is contained in the detergent of the present invention in an amount of preferably from 0.2 to 20% by weight, more preferably from 0.6 to 15% by weight, and even more preferably from 1 to 10% by weight, from the viewpoint of cleaning performance and suitability of coating clothes with the detergent.

In addition, the detergent of the present invention contains the above-mentioned water-soluble pectin as a cleaning ingredient, and may contain an agent which is generally used in a detergent, for example, an optional component such as an alkalizing agent, a surfactant, an agent for sequestering water hardening substances, a perfume, an enzyme, or a preservative.

In the detergent of the present invention, from the viewpoint of more effectively retaining the effect of the detergent, a component such as an alkalizing agent is contained in an amount of preferably 2% by weight or less, and more preferably 0.5% by weight or less. Even more preferably, the detergent contains substantially no such component. Specifically, it is preferable that the detergent contains substantially no alkalizing agent, or an amount of the alkalizing agent is 2% by weight or less in a case where it is contained.

In addition, the balance of the detergent of the present invention is water. The detergent of the present invention has an advantage such that the cleaning ingredient pectin can be permeated into the inside of the cloth where the mechanical force is less likely to be applied.

The detergent of the present invention can be prepared by mixing the water-soluble pectin and water, and, if necessary, any component, by a known method.

The detergent of the present invention is preferably in a form of a liquid, from the viewpoint that the detergent can be easily spread out when applied to stains of fabric. Accordingly, the present invention relates to a liquid detergent for fabric.

The liquid detergent for fabric according to the present invention (hereinafter also referred to as the liquid detergent of the present invention) contains a water-soluble pectin.

In the present invention, the term “fabric” refers to fibers including a natural fiber such as cotton, hemp, silk, and wool; a synthetic fiber such as polyester, nylon, and acrylic; a regenerated fiber such as cupra; a semisynthetic fiber such as acetate; and the like. Therefore, the liquid detergent of the present invention is intended for washing away stains adhered to household textiles such as clothes, towels, bedclothes, and curtains; fabric products such as fabric shoes, each being made of these fibers, and especially, solid stains such as dirt stains and dust stains.

It is also preferable that the above-mentioned water-soluble pectin is used in combination with a surfactant in the liquid detergent of the present invention, from the viewpoint of further improving the cleaning performance.

The present invention has an advantage such that the permeation of the liquid detergent is accelerated into a cloth by using the water-soluble pectin in combination with a surfactant, thereby improving the cleaning performance.

The surfactant is not particularly limited, as long as the surfactant is used in ordinary detergents. For example, anionic surfactants such as a linear alkylbenzenesulfonate, an alkyl sulfate, and an α-sulfofatty acid alkyl ester; nonionic surfactants such as a polyoxyethylene alkyl ether, and an alkyl glycoside; or the like can be used.

The surfactant is contained in the liquid detergent of the present invention in an amount of preferably from 1 to 40% by weight, and more preferably from 5 to 25% by weight, from the viewpoint of cleaning performance and suitability of coating clothes with the detergent.

In the liquid detergent of the present invention, from the viewpoint of more effectively retaining the effect of the detergent, a component such as an alkalizing agent is contained in an amount of preferably 2% by weight or less, and more preferably 0.5% by weight or less. Even more preferably, the liquid detergent contains substantially no such component.

The balance of the liquid detergent of the present invention is water. The water is not particularly limited, and includes ion-exchanged water, distilled water, and the like.

The liquid detergent of the present invention can be prepared by mixing the above-mentioned water-soluble pectin and water, and, if necessary, a surfactant and any component, by a known method.

Incidentally, the term “liquid” used herein refers to one having flowability at 25° C. Here, the presence or absence of flowability is defined as follows: Specifically, a cylindrical glass container is provided, which is in a cylindrical shape having an inner diameter of 30 mm and a height of 40 mm, with one of the two circular end faces having an opening in a form of a circle having an inner diameter of 30 mm. The container is placed on a level surface, its opening facing upwardly and perpendicular thereto. A 20 cm³ sample is placed therein, and the container is allowed to stand at 25° C. for 10 minutes. Thereafter, the sample is defined as having flowability when the container is tilted at 90 degrees, and the contents are allowed to flow to reach the opening portion of this glass container within 1 hour.

The detergent or liquid detergent for fabric of the present invention is suitably used for washing, specifically washing away solid stains.

As a use embodiment, the method for application of a detergent is preferable. The method for application, includes, for example, a method including the steps of applying a detergent or liquid detergent for fabric of the present invention to a fabric product, especially stains thereof, and then carrying out wet cleaning.

As the method for application, for example, a detergent can be directly applied using a spray, a nozzle container or the like, or indirectly applied using a sponge, a sheet or the like which is impregnated with the detergent or liquid detergent for fabric.

Washing may be carried out immediately after the application or after a period of time has passed. The applied detergent or the applied liquid detergent for fabric may be in a wet state or a dry state.

The amount of the detergent or liquid detergent for fabric of the present invention used cannot be necessarily determined since the detergent or liquid detergent depends upon the kind or form of the fabric. It is preferable to use an amount sufficient for the agent to permeate into the inside of the cloth. For example, when washing is carried out by applying the detergent to a fabric product for clothing, the concentration of the water-soluble pectin in the detergent is preferably 15% by weight or less, and more preferably 10% by weight or less.

In addition, there is an advantage such that the applied pectin is more easily washed away when washing is carried out by further adding a known detergent during the above-mentioned washing, thereby improving the cleaning performance. The detergent to be used together is not particularly limited, and may be an ordinary detergent for clothes.

In addition, the washing method is not particularly limited, and includes hand-washing, washing using a washing machine, and the like. The present invention has an advantage such that a sufficient cleaning effect can be conveniently obtained even in washing with a washing machine even with a weak mechanical force.

As described above, the detergent or liquid detergent for fabric of the present invention also has an especially remarkable cleaning effect on solid stains. Also, the detergent or liquid detergent has sufficient detergency against stains such as food-based stains even when used in place of a usual liquid detergent.

### EXAMPLES

[Preparation of Artificial Stained Cloth (Dirt)]

An artificially stained cloth was prepared by smearing dirt (Kanuma red clay) to a knitted cotton cloth (dye test material manufactured by Tanigashira Shoten, trade name: A-10 (bleached, mercerized calico)) in accordance with the method described in Example 1 of JP-A-Hei-10-204769.

[Preparation of Artificial Stained Cloth (Carbon)]

One gram of a carbon black (purchased from Sentaku Kagaku Kyokai) was added to 1 L of ethanol, and the carbon was dispersed therein for 10 minutes using an ultrasonic oscillator. Thereafter, the above-mentioned knitted cotton cloth was immersed in the dispersion and then dried, to prepare an artificially stained cloth.

### Examples 1 to 8 and Comparative Examples 1 to 3

Each component was mixed so as to have the composition listed in Table 1, to prepare a liquid detergent.

As for the resulting liquid detergent, the detergency ratio against the dirt-stained cloth and that against the carbon-stained cloth were determined in accordance with the following method.

[Washing Conditions]

Three grams of the liquid detergent was directly applied to one piece of the artificial stained cloth (dirt or carbon) having a size of 6 cm×6 cm, and thereafter washed. The washing was carried out using a Terg-O-Tometer at a rotational speed of 80 rpm for a washing period of 10 minutes at a temperature of 20° C. using 1 L of water of 3° DH (Ca/Mg=7/3).

Calculation of Detergency Ratio

The reflectance of the unstained cloth and those of the stained cloth before and after washing (460 nm for the dirt-stained cloth, 550 nm for the carbon-stained cloth) were determined with a colorimeter (ND-300A, manufactured by Nippon Denshoku Kogyo K.K.), and the detergency ratio D (%) was calculated in accordance with the following equation. The results are shown together in Table 1.

D=[(L₂−L₁)/(L₀−L₁)]×100(%)

wherein:
L₀: Reflectance of Unstained cloth
L₁: Reflectance of Stained Cloth Before Washing
L₂: Reflectance of Stained Cloth After Washing

TABLE 1

| | Example No. | | | | | | | | Comp. Ex. No. | | |
|---|---|---|---|---|---|---|---|---|---|---|---|
| | 1 | 2 | 3 | 4 | 5 | 6 | 7 | 8 | 1 | 2 | 3 |
| Pectin 1 (% by weight) | 0.3 | 0.6 | 2 | 5 | 5 | 5 | 0 | 2.5 | 0 | 0 | 0 |
| Pectin 2 (% by weight) | 0 | 0 | 0 | 0 | 0 | 0 | 5 | 2.5 | 0 | 0 | 0 |
| Surfactant (% by weight) | 0 | 0 | 0 | 0 | 10 | 20 | 0 | 0 | 0 | 10 | 20 |
| Water | Bal. | Bal. | Bal. | Bal. | Bal. | Bal. | Bal. | Bal. | Bal. | Bal. | Bal. |
| Detergency Ratio of | 22.6 | 32.6 | 37.5 | 42.6 | 50.3 | 56.1 | 43.5 | 42.5 | 18.6 | 19.5 | 20.3 |
| Dirt-Stained Cloth (%) | | | | | | | | | | | |
| Detergency Ratio of | 25.4 | 32.4 | 42.1 | 47.5 | 51.3 | 56.5 | 46 | 47.2 | 23.8 | 40.5 | 40.6 |
| Carbon-Stained Cloth (%) | | | | | | | | | | | |

Here, the components listed in the table were as follows:
Pectin 1: UNIPECTINE SS150 apple HM pectin (manufactured by Degussa Texturant Systems Japan K.K.), manufactured in March, 2004, Lot: 31213707
Pectin 2: UNIPECTINE LM SN325 apple LM pectin (manufactured by Degussa Texturant Systems Japan K.K.), manufactured in March, 2004, Lot: 30435202

It can be seen from the results in Table 1 that the detergency ratios against the dirt and carbon stains are significantly improved in the liquid detergents containing a water-soluble pectin (Examples 1 to 8). as compared to those containing no pectin (Comparative Examples 1 to 3).

### INDUSTRIAL APPLICABILITY

The detergent and liquid detergent for fabric of the present invention are preferably used for washing household textiles such as clothes, towels, bedclothes, and curtains, fabric shoes, and the like, especially, washing away solid stains such as dirt and dust.

1. A detergent comprising a water-soluble pectin as a cleaning ingredient.

2. The detergent according to claim 1, wherein the water-soluble pectin is one or more members selected from the group consisting of pectinic acid and pectic acid.

3. The detergent according to claim 1, wherein the water-soluble pectin is contained in an amount of from 0.2 to 20% by weight.

4. The detergent according to claim 1, wherein the detergent contains substantially no alkalizing agent, or an amount of the alkalizing agent is 2% by weight or less in a case where it is contained.

5. The detergent according to claim 1, further comprising a surfactant.

6. The detergent according to claim 5, wherein the surfactant is contained in an amount of from 1 to 40% by weight.

7. The detergent according to claim 1, wherein an object to be washed is solid stains.

8. A liquid detergent for fabric, comprising a water-soluble pectin.

9. The liquid detergent for fabric according to claim 8, wherein the liquid detergent is used by applying to stains.

10. A method for washing a fabric product, comprising the steps of applying the liquid detergent for fabric as defined in claim 8 or 9 to a fabric product, and then carrying out wet cleaning.
